(19) United States
(12) Patent Application Publication
(10) Pub. No.: US 2010/0138304 A1
(43) Pub. Date: Jun. 3, 2010

(54) ITEM ASSESSMENT SYSTEM

(75) Inventors: Oleg D. Boyarsky, Cherry Hill, NJ (US); David Boyarsky, Cherry Hill, NJ (US)

Correspondence Address: JOHN F. LETCHFORD, ARCHER & GREINER, P.C., ONE CENENNIAL SQUARE, HADDONFIELD, NJ, 08033, US

(73) Assignee: LIBRARY AUTOMATION TECHNOLOGIES, INC., Somerdale, NJ (US)

(21) Appl. No.: 12/627,098

(22) Filed: Nov. 30, 2009

Related U.S. Application Data
(60) Provisional application No. 61/118,779, filed on Dec. 1, 2008.

(51) Int. Cl. G06Q 30/00; G06K 15/00; G06F 17/00; G06Q 99/00; G06F 3/041

(52) U.S. Cl. 705/14.65; 235/383; 235/375; 705/346; 345/173

(57) ABSTRACT

A system that uses an essentially stationary device to scan barcodes or the like associated with items such as retail goods and services, library books, and so on. The system further includes an interactive graphical user interface that enables consumers to obtain a wealth of information about the scanned items and items similar in kind and/or different in kind but related in purpose to the scanned items, as well as promotional events and selling opportunities associated with the scanned items. The system allows a consumer to involve social knowledge in the decision making process of borrowing or purchasing a particular item. In an instant, the consumer can get a sense of an item's benefit to him or her based on the publicly available opinions of others. The system may be used to instantly check out items, communicate with staff, function as digital signage or to locate items in a facility.

### CROSS REFERENCE TO RELATED APPLICATION

The present application claims the benefit of U.S. Provisional Patent Application No. 61/118,779, filed Dec. 1, 2008, which is incorporated herein by reference in its entirety.

### FIELD OF THE INVENTION

The present invention relates in general to systems for assessing items (e.g., goods and/or services) in retail, library and related environments. In particular, the invention relates to a system for enabling a user to assess an item and related items by introducing, such as by scanning or the like, an item code into the system.

### BACKGROUND OF THE INVENTION

Oftentimes, when in a library environment looking for a particular book or other item to read, view, listen to or research, one has very little information or guidance as to what he or she really needs. Nearly every book one picks up makes claims of being superior in one form or another, but yet they do not provide an objective critical view of their content and/or validity. Additionally, asking someone for an opinion is also flawed, especially when considering highly technical books, or books on health (where privacy might be a concern) or something that is highly esoteric, which very likely limits the library staff's knowledge of the topic. Under these circumstances, one is often at a loss as to what to do. How does one tap the wealth of information that exists in the common space and bring it to his or her decision-making process while standing in the middle of an aisle trying to select a book? The same scenario also applies to bookstores, airport newsstands, and the like. Thus, from a patron's standpoint, there is a considerable lack of resources available to quickly and instantly get not only information about an item of interest but also a social “feel” as to how this item might be relevant to “me”, the consumer.

From the library staff perspective, there exists an inherent set of related problems. For instance, the staff has very little knowledge of the wants or needs of the public they serve. The essential purpose of a library or bookstore is to provide relevant information and resources to the local community it serves. But, how does the library know what the community needs? There are no clear channels of communication between the local public attending the library that lets it know what it truly wants. The resulting action is that libraries simply “sprinkle” their buying or collection acquisitions process over a wide range of subjects and topics. Considering that a significant percentage of the library's operating budget is dedicated to collection acquisition, literally hundreds of millions of dollars are annually spent on the “sprinkle” method. The end result is very shallow coverage of a wide variety of topics, many of which have no relevance to the needs of the local population. For example, a library serving a poor Chicago inner-city neighborhood may have different needs for its collection than a library that is located in upper Connecticut, yet they may “sprinkle” their collections with similar types and titles of books. In short, significant resources are directed to collection growth in volume, but not necessarily to popularity or usefulness.

Another fundamental and nearly universal problem is the shortage of trained staff to assist people in a library. A simple question or request requires effort to find a staff member that is nearby. Further, one must frequently get into a queue of those being served, since staff are commonly already busy with others' requests. In addition, many libraries now allow telephonic, web-based and even short message service (SMS)-based requests into the library (all fielded by staff). Consequently, the availability of “free time” and or free staff personnel is extremely limited.

Finally, just as the communication between the local community and the library is limited or virtually non-existent, the same goes for the communication between the library and its patrons. Libraries dedicate an enormous amount of resources on various activities, seminars, collection acquisitions, purchases, paid database subscription access, and so on, most of which go unused largely because few people know about them. There are many articles, blogs and commentaries on the critical need for libraries to now “market” themselves to the public they serve or run the risk of obsolescence. Libraries must now compete for people's attention to market the value that they provide to the community—something that they have never had to do in the past.

In retail contexts, there is another yet similar set of inherent problems that the consumer faces. That is, as soon as he/she walks into any retail establishment, the consumer has only two primary factors that affect their purchasing decision. These are: (A) the description of the item of interest on its packaging, and (B) price. Virtually every item's packaging text will extol its virtues as being the best at whatever it is supposed to do, without revealing any of its flaws and limitations. The only true influence that the store has on the packaging is the placement of the item on the shelf relative to the customer's field of vision. The other factor, price, is controlled by in-store promotions, discounts, and the like. There is absolutely nothing in the store that enables the consumer to make an informed and low-risk decision about an item. Certainly one can ask a sales representative about an item, but that assumes that the sales representative is available and, more importantly, is knowledgeable about the item. Accordingly, the customer has extremely limited information about the item of interest, and certainly no critical information about its usefulness, longevity or even quality. It should be noted that some retail stores recognize this problem, and some attempt to mitigate the risk of consumers buying something that may not necessarily fit their needs by offering hassle-free returns—a very expensive proposition.

What about up-selling and cross-selling opportunities that relate to an item that might be needed? Retailers spend millions of dollars annually on ads and flyers promoting a very limited set of products in hopes that customers will remember them, act on the promotions and come into the stores. However, there is limited promotional information in stores when customers are already inside the stores. That is, there is very little in-store promotional information for the customer that has already made the trip to the retailer.

Furthermore, particularly in specialty stores, customers may not be knowledgeable as to what exactly it is that they need. They may have an idea, a goal or a project in mind with very little information as to what is needed to realize the goal. For example, if a customer needs to install a flat-screen television, they may know they need a television, but they do not always know they may also need (a) a set of connectivity cables, (b) a transient power protection strip, (c) possibly a TV stand, (d) supporting wall brackets, and (e) in some cases, a tuner, and so on. Or, if one needs to “repaint a deck”, he or she may ask “What do I need to do the job?” These are typical examples of how the customer knows the desired “end result” but may not necessarily know the items or the method needed to achieve this result.

An advantage exists, therefore, for an easy-to-use system for enabling a user, such as, for example, a library patron or a retail store consumer, to quickly learn in real time a plethora of information about an item such as a book or a consumer product or service.

A number of systems are known which employ a portable computing unit or “mobile device” such as a cell phone, a personal digital assistant (PDA), smart phone, or the like that permits a user to perform various functions with respect to a retail item or a retail outlet. Examples of systems employing mobile devices for this purpose are varied, for instance:

Published U.S. Patent Application No. 2007/0228163 describes the concept of a consumer who uses a mobile device to query a retail establishment's enterprise resource planning (ERP) system to answer questions like “Is a particular item in stock?”, “In what store is it available?” and so on.

Published U.S. Patent Application No. 2006/0289635 involves use of a mobile device as a means of locating products and determining quantities thereof in a retail establishment. Similarly, U.S. Pat. No. 7,386,477 describes using mobile devices to inform consumers of the availability of items of interest in immediately surrounding stores as they walk through a shopping mall.

Published U.S. Patent Application Nos. 2004/0254829 and 2005/0003839 describe using radio frequency identification (RFID) technology to enable mobile devices to scan items in a store and have the system access, via the Internet, a manufacturer's data to provide item information, coupons and the like.

U.S. Pat. No. 6,434,530 involves an interactive mobile device that permits a consumer to get additional information about an item beyond that which can be obtained by simply looking at the item. The device enables the consumer to walk around a store while querying the device for information and receiving responses to those queries. Also discussed is the use of artificial intelligence as a means of interpreting user inquiries.

Published U.S. Patent Application No. 2006/0169772 discusses the use of RFID-based product scanners that are connected to mobile devices for providing the mobile devices with product information. The scanned information is returned in the form of a webpage displayed on the mobile device.

Published U.S. Patent Application No. 2005/0198095 and U.S. Pat. No. 7,287,696 describe mobile device barcode scanning and decoding, whereby a remote server returns media content (e.g., product information) that can be seen on the mobile devices.

Published U.S. Patent Application No. 2005/0091124 uses barcode scanning by a mobile device to assist a user in making a purchasing decision.

A significant disadvantage of using mobile devices to perform any of the foregoing tasks is the requirement of the mobile device itself as an essential component in the system. That is, without the mobile device, the systems discussed above will simply not function, or even exist. This is disadvantageous for users who either do not own or do not like to carry mobile devices on them at all times. In many instances, it also requires that the mobile devices be equipped with specialized hardware and/or software to permit the devices to perform their dedicated navigational or RFID/barcode scanning functions. Many users simply do not want to be bothered with acquiring these functionalities for their mobile devices—let alone learning how to operate the appropriately equipped mobile devices.

As is known, price checkers are essentially stationary devices that are commonly situated at spaced-apart locations throughout medium- to large-sized retail establishments. Their purpose is simple: to enable a shopper to scan the barcode of a retail item to determine its cost. Although simplistic, they do have an advantage over mobile devices in that they do not have to be carried around a store by a user in order to perform their dedicated function.

An advantage exists, therefore, for a system that uses stationary means to scan barcodes or the like such as UPC (Universal Product Code), ISBN (International Standard Book Number) or other codes associated with items such as retail goods and services, books and the like, in order to obtain more than price information from the codes.

In this regard, U.S. Pat. No. 6,651,053 discloses the use of wired or wireless computing devices for scanning UPCs and ISBNs in order to derive information about items whose barcodes are scanned. More specifically, the system described therein employs a barcode scanner in communication with a wired or wireless computing device. The computing device communicates with an implementing server which, in turn, is connected to a local site and the Internet for obtaining and providing information about the barcodes being searched. The computing device may contain a database for containing a library of barcodes therein. In operation, a user of the system scans an item using the barcode scanner and enters an optional product category which together set into motion a search of information relating to that item. The results of the search may include product-related and manufacturer information, including the name of a source for purchasing an item, whereby the implementing server may link the computer with the source's web site to permit direct ordering from the source's web site. That is, the direct link to the source's web site directs the consumer “where to buy” the desired item. While direct ordering in this respect has some utility, one must still contend with the time and, commonly, expense associated with shipping of the item from the retailer or its distributor to the customer. That is, the system disclosed in U.S. Pat. No. 6,651,053 does not permit a spontaneous, on-the-spot, point of sale purchase of the item at the computing device itself. In addition, the consumer using the wireless version of the system disclosed in U.S. Pat. No. 6,651,053 is encouraged gather a “wish list” of UPC information on his or her wireless device and transfer that information to another mobile device or landline computer for later analysis.

Furthermore, the system disclosed in U.S. Pat. No. 6,651,053 does not afford the consumer access to similar or related items or real-time, on-site, sales promotions which might be of interest to the consumer during the purchasing process. For example, a user is not offered (a) similar alternatives to the selected item, (b) items that may be useful when purchased in conjunction with the selected item, (c) sales, rebates or other discount opportunities, or (d) up-selling or cross-selling options that might benefit both the retailer and the consumer.

A further advantage exists, therefore, for a system that enables a consumer to not only make a point of sale purchase of an item upon scanning of the item but also be offered (a) similar alternatives to the selected item for price and/or qualities comparisons, (b) related items that may be useful when purchased in conjunction with the selected item for “bundling” purposes, (c) sales, rebates or other discount opportunities, or (d) useful up-selling or cross-selling options.

### SUMMARY OF THE INVENTION

The present invention is a system that uses a device to scan barcodes or the like such as UPC (Universal Product Code), ISBN (International Standard Book Number) or other codes associated with items such as retail goods and services, books, and so on. The system enables consumers to obtain a wealth of information about the scanned items and items similar in kind and/or different in kind but related in purpose to the scanned items, as well as promotional events and cross-selling or up-selling opportunities associated with the items.

The system comprises an essentially stationary combined barcode reader (scanner) and interactive graphical user interface that is supported on or by any suitable stable structure such as a table, counter top or a bar, beam or similar member. Similar to a “price checker” it may be located virtually anywhere there is consumer traffic in a library, retail outlet or other establishment. For economy of space, the barcode reader is preferably contiguous or integral with the graphical user interface. The device may be connected wirelessly or by wire to an on-site or remote server. It is also worthy to note that no server may be required since the system may be architected to derive all of its information from the Internet or web-based sources.

In the library context, the system according to the invention allows a library patron to involve the overall web-available “social knowledge” or social mindset in the decision making process of borrowing a particular item. Independent of the library's internal tracking system or barcodes, the present system preferably obtains readily available information about an item as well as reviews and ratings of the item as judged by the borrower's peers. Thus, in an instant, the patron can get a “feel” or “sense” of the item's benefit to him or her based on the publicly available opinions of others. This is capability is extremely valuable since the patron now is empowered with the growing wealth of knowledge targeted to a particular item.

Additionally, similar items related to the scanned item can also be recommended by the device. If selected by the user, such items can likewise be propagated through the device to get the “social feel” for those items as well. This process can occur unlimited number of times.

The user is never authenticated (unless he or she wants to be). The item may be identified by either an ISBN code or in the case of retail, UPC code via a barcode scan (or RFID scan). The system further allows live, extensive ability to communicate with local and remote staff on any matter (related or unrelated to an item) as well as the ability to “request” items that are not currently available, request assistance, and so on. In a library environment, if the user so chooses, he or she can look up other social content, such as a friend's “book shelf” (list of preferred books or other preferred items), or a friend's recommendation. Moreover, a user can access common sources such as best-seller lists or other sources of significance to the patron in order to first research and then request an item if the library does not have it in its collection. For example, the question “Who is currently in the top 5 on the New York Times Best Seller's list?” can now be answered while the patron is in an aisle selecting materials.

The system's ability to communicate at any time either about the selected item or any other library-related matter enables the library to effectively augment the existing staff to serve more patrons simultaneously. In addition, the user has controlled access into the library's activities information, such as the current calendar, list of events, or latest collection acquisitions. Consequently, the library now has a clearly defined and very effective method for marketing their activities, services and value-ads through a single interface. In the retail context, discussed in more detail below, the ability to contact staff enables the user to quickly request store assistance when needed.

The system's screen design desirably provides dedicated space or real estate for various follow-up activities that the patron might be interested in, as well as items that might relate to the search currently being conducted. For example, if a user is inquiring about an item that deals with “eBay”, the library might set up the system to display a list of “How to sell on eBay” classes that the library offers on the side of the screen. The possibilities are endless.

The system according to the invention also allows similar problems to be solved in the commercial context. By way of example but not limitation, the system's interactive device may be located at end of each aisle in a store. Resembling a price checker, the device allows the user to simply scan the item of interest to immediately acquire any social content for that item as well as reviews of the item submitted by the user's peers. Based on ratings and various opinions about the item, the customer is now empowered to make the best possible decision. The source of opinions can come from any data stream, or can be provided by the retail establishment itself. The device may also suggest items that are similar in kind to the item scanned.

In addition to providing a wealth of information about an item, the user also has an option of defining a particular task he/she is interested in performing (e.g., painting a deck) and have the system generate a list of items and even tasks that need to be performed to accomplish the project, i.e., items or tasks related in purpose to the project. The results can be printed or even SMSed (“texted”) to the user's cellular phone, PDA, or the like. In addition, a number of unique “on the spot” marketing propositions can be developed based on the item scanned, location of the device, the current inventory levels of the items and myriad other functions. For instance, if the user scanned a hammer, he may be prompted to get an additional 10% off the price of the hammer if he buys nails to go with it.

Further, since many retail stores try to accommodate a variety of product categories within the same store, it is often very difficult to locate when specific items or item categories are available. As part of the information stream about an item, information as to its location and dynamically generated directions can be provided as needed (a/k/a “wayfinding”).

Not only does the instant system provide tremendous value to the consumer experience, it affords retailers unprecedented data and visibility into customer patterns, interests and moods. The present system engages the customer for the time in which when they scan an item in and interact with the system. This is highly valuable to the store owner. Furthermore, since the customer can communicate with staff via the device at any time, the staff support function can be remotely outsourced to subject matter experts. Such experts can even be centralized and located off premises and yet still provide a high-quality customer experience.

The captured data is also invaluable in weeding out inventory based on what customers are actually asking about and/or scanning, in optimizing product placement, and sharpening of the marketing message.

Additionally, in idle modes when the device is not used for a certain period of time, the basic screen preferably reverts to a digital sign display. According to preferred embodiments, not only can the digital message be defaulted to something of general or specific interest, it can also be dynamically adjusted based on items that have been scanned through the system to present any desired imagery. Hence, from a simple display, the digital signage capability may become adaptable and “smart”. The retail establishment or the library thus have full control over the content presented when display screen is in the “digital signage” mode.

Summarizing, the operation of the device is generally as follows. The user scans the ISBN of the item (or in the case of retail applications the standard UPC code of the item). Once scanned, in the case of the library environment, immediate social reviews and ratings preferably appear for the item on the graphical user interface display screen. In the case of retail, item information as well defined ratings or item information desirably appears. The user can then simply touch or click “similar” or a corresponding function button or key to get items similar in kind or type to the item scanned via a “Similar Window” that appears. The user can then select an item from the “Similar Window” to obtain the initial information (e.g., reviews/ratings) on the similar item. In addition to the information already provided, the user can press a “More” or corresponding button to get an even more in-depth informational view of the particular item to appear. Since the system preferably includes a live web browser interface, the user can interact with any screens live and in real-time. Moreover, when in idle mode, the user can inquire about current activities, promotions or events offered by the library or commercial establishment.

The system is designed as a platform that houses data-drivers that provide the ability to obtain various data streams from any source, without affecting the device operation. Unless required, all of the data sources are free and are publicly available. No data is ever stored by the device. In the idle mode, when the system is not actively used, the user interface turns into a “digital display” device showing whatever images/slide show may be appropriate for the location at which the system is situated. The system may be fully controlled by control system software that can modify anything about the system live and in real-time, as well as obtain statistical measures on its use. The data-drivers concept allows virtually any data stream to be “plugged in” into the system as a data source.

Still further, the system can also serve as an on-the-fly purchasing/reservation station. That is, the system preferably includes means for allowing items to be instantly checked out and applied to the users account. In the case of retail or similar commercial applications, this means instant point of sale purchase of items and, in the case of libraries, instant reservation of books, music, video or other items that might be available for loan by a library.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a perspective view of an item scanner and interactive graphical user interface of the item assessment system according to the present invention;

FIG. 2 is a perspective view similar to FIG. 1 showing how a user scans an item such as a book to initiate interaction with the system;

FIG. 3 is a view of a typical startup or idle screen that might appear on the interactive graphical user interface screen prior to scanning of an item;

FIG. 4 is a view of a typical reviews screen a user might encounter upon scanning an item into the system;

FIG. 5 is a view of a typical “similar items” screen a user might encounter upon pressing the “Similar Items” button of the ratings screen of FIG. 4;

FIG. 6 is a view of a typical more information screen a user might encounter upon pressing the “More Information” button of the ratings screen of FIG. 4;

FIG. 7 is a view of a typical screen showing sign-in boxes of social networking sites for enabling a user to access what his or friends may be reading;

FIG. 8 is a view of a typical screen showing what a user's friends are reading;

FIG. 9 is a view of a typical “contact staff” screen a user may deploy to obtain or request information about an item;

FIG. 10 is an on-screen, pop-up keyboard that the user can activate as needed;

FIG. 11 is a view of a typical idle screen which includes sales promotional options on the screen;

FIG. 12 is a view similar to FIG. 11 of a typical reviews/ratings screen showing other types of sales promotional opportunities that may be made available to a user;

FIG. 13 is a view of another typical idle screen that might appear prior to scanning of an item;

FIG. 14 is a full-screen version of the idle screen of FIG. 13; and

FIG. 15 is a schematic view of the system architecture of the item assessment system according to the invention.

### DETAILED DESCRIPTION OF THE INVENTION

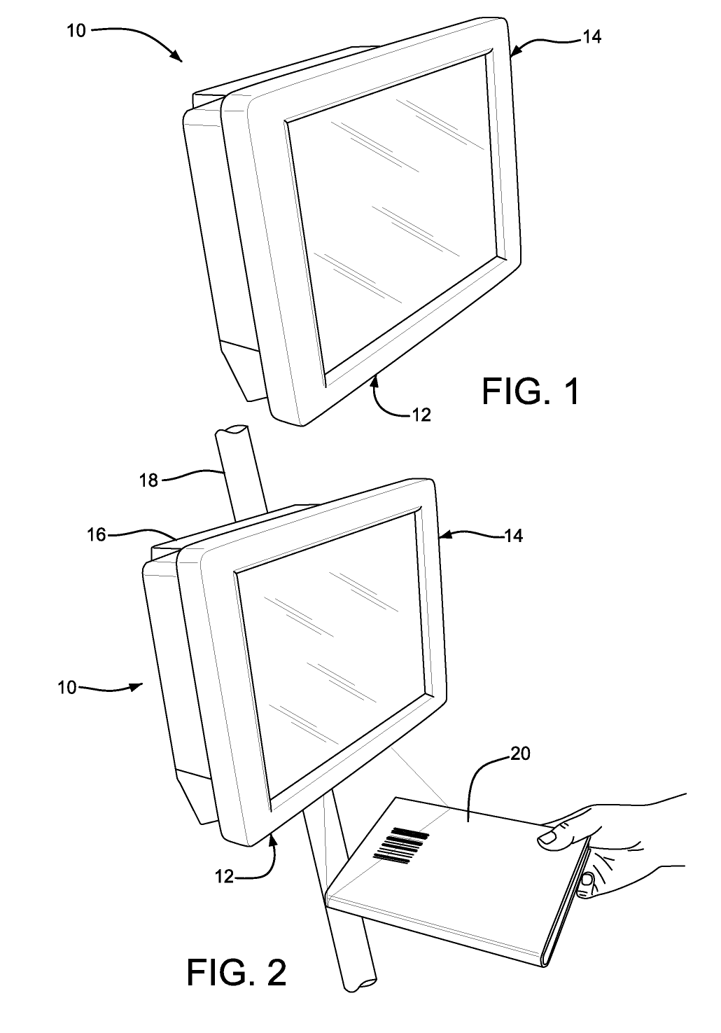

Referring to the drawings wherein like or similar references indicate like or similar elements throughout the several views, there is shown in FIGS. 1 and 2 an item assessment system according to the present invention identified generally by reference numeral 10. System 10 preferably includes an item code scanning means 12 and an interactive graphical user interface means 14 in communication with the scanning means. Although not required, in the interest of economy of space, it is preferred the scanning means 12 be contiguous or integral with graphical user interface means 14. While shown on the bottom of graphical user interface means 14, it will be understood that scanning means 12 may be located along the top, either side or back of means 14 if such is desired or necessary. Alternatively, scanning means 12 may be a wand or similar hand-held scanning device known in the art which may be wired or wirelessly connected to graphical user interface means 14. As is known, scanning means 12 is operable to scan UPC, ISBN or other codes associated with items such as retail goods and services, books and the like. In this regard, scanning means 12 may include magnetic stripe or RFID scanning capability. And, device 10 may include an optional unillustrated printer for providing receipts reflecting and memorializing users' interactions with system 10.

Graphical user interface means 14 may be a keyboard and/or mouse in wired or wireless communication with a display screen. Preferably, however, means 14 is a touch-screen display whereby a user may interact with the screen by pressing different areas of the screen which correspond to different functionalities (e.g., buttons, links, and the like) to achieve desired results.

Referring to FIG. 2, it is seen that the system 10 is desirably essentially stationary in nature. In this regard, system 10 preferably includes mounting means 16 for securing the graphical user interface means 14 to a suitable structure such as a bar or beam 18 (or an unillustrated counter or table top). It will be understood that system 10 may be removed for maintenance, repair or replacement when appropriate. It will be further understood that system 10 may be mounted on a wheeled cart or pole which is moveable about a facility for the convenience of the facility. That is, system 10 may be moved on occasion by authorized personnel for legitimate business purposes. However, under normal operation, system 10 will be essentially stationary in the manner of a conventional “price checker” device. In this way, a user simply scans a code-bearing item 20 (e.g., a book or other retail item) via scanning means 12 to begin interaction with the graphical user interface means 14. The user does not have to use a personal mobile device such as a PDA, cell phone or the like to interact with system 10. And, it will be understood that multiple systems or stations 10 may be located throughout a facility such as a library or store, or the like, for customers or patrons convenience. Also, as referred to herein, the term “item” includes not only tangible items such as, for example, retail goods, but also symbolic items such as coupons, tags, labels, advertisements or other identifiers of both goods and services.

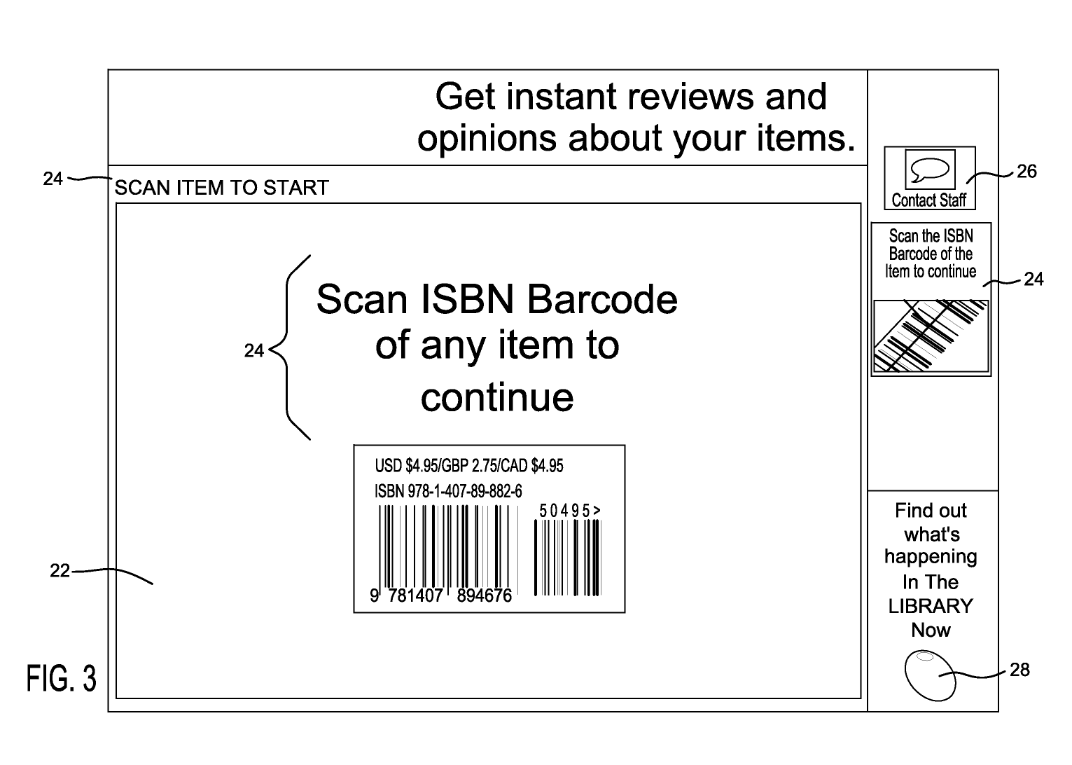

Referring to FIG. 3, there is shown a typical “library context” startup or idle screen 22 that might appear on the interactive graphical user interface display prior to scanning of an item. More particularly, idle screen 22 may contain one or more instructions 24 instructing the user to scan an ISBN barcode to continue. It will be understood that similar scanning start-up directives may be provided as well in the retail context. In addition, idle screen 22, may contain additional buttons or other interactive prompts. For example, it may include, without limitation, a “contact staff” button 26 (the activation of which is discussed in greater detail below) and a “Find out what's happening in the library now” button 28. Pressing or otherwise activating button 28 opens a new screen (not shown) which presents a current list of presentations, classes, seminars, and other events being offered by the library.

Significantly, buttons 26 and 28 represent actions that can be taken by a patron in interacting with system 10 prior to ever scanning an item by scanning means 12.

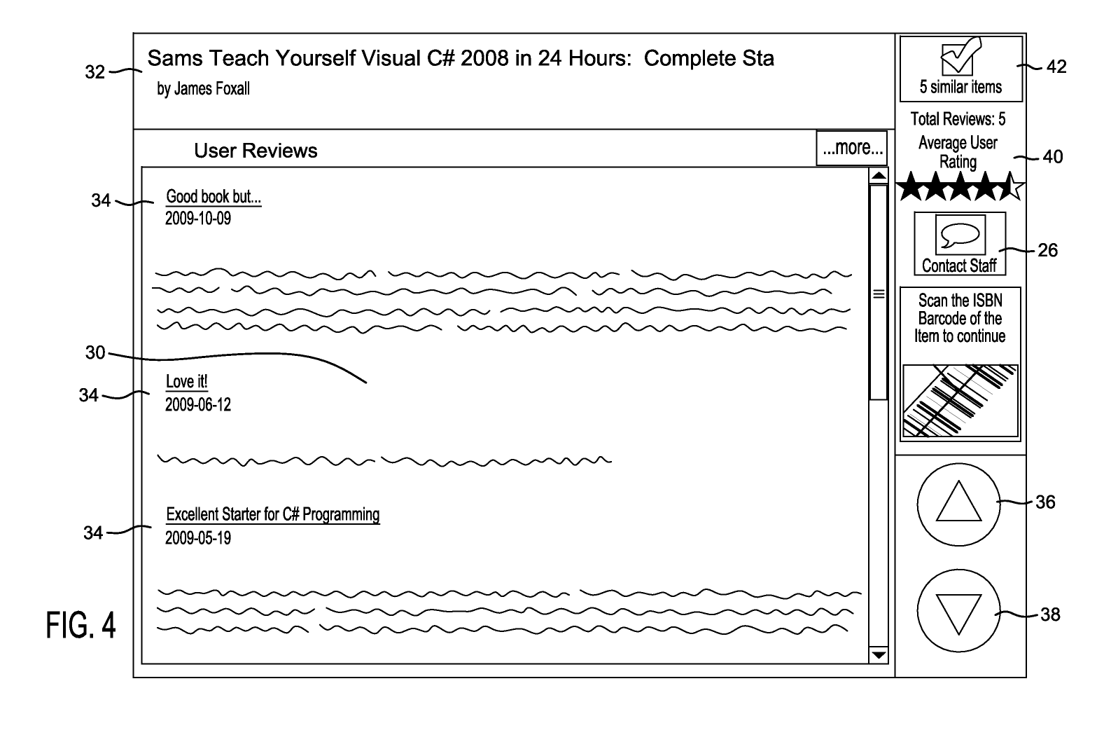

FIG. 4 is a view of a typical reviews screen a user might encounter upon scanning an item into the system. By way of example but not limitation, screen 30 of FIG. 4 represents a “reviews screen” for a book whose ISBN has been scanned by the scanning means 12. At the top of screen 30 is desirably the title of the book 32 (or the name of the product or service in a commercial context). Screen 32 also preferably includes a “contact staff” button 26 (again, described below). Appearing generally centrally in screen 30 is one or more written reviews 34 of the scanned book (or other item). In this regard, screen 30 is preferably equipped with scroll-up and scroll-down buttons 36 and 38, respectively, to enable a user to scroll through and read as many reviews as may be posted about the item or as many as the user desires to read.

Screen 30 also desirably includes a ratings notification section 40 which informs the user of the total number of reviews about an item as well as the average user rating for the item, e.g., based on a multiple star rating system.

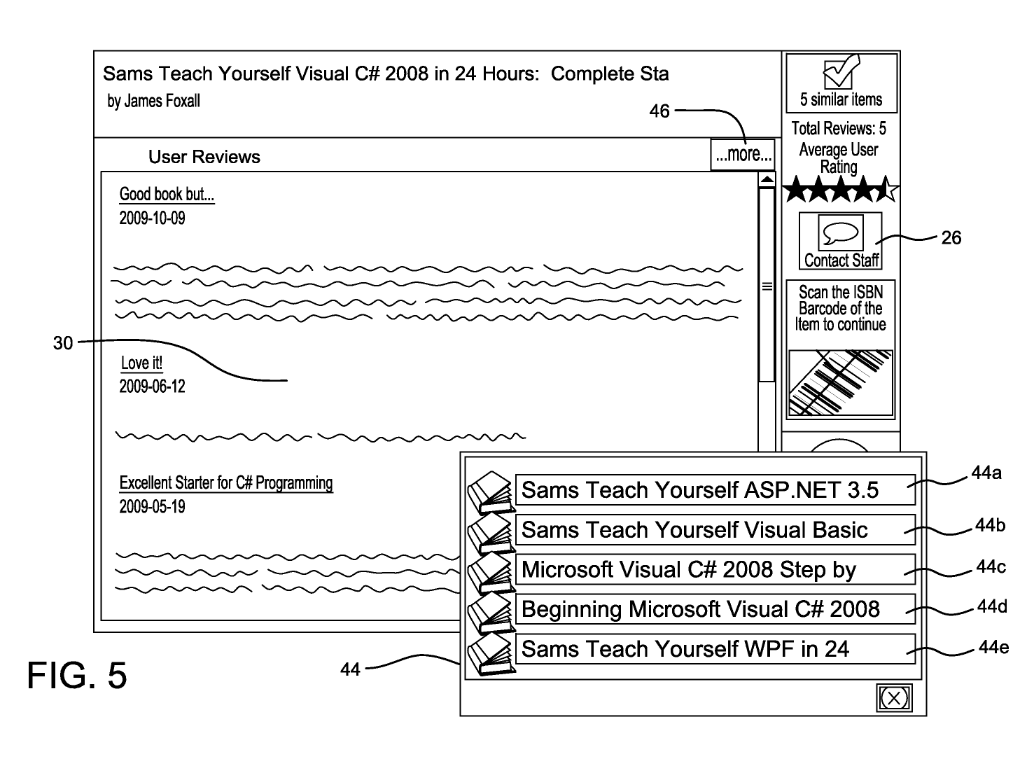

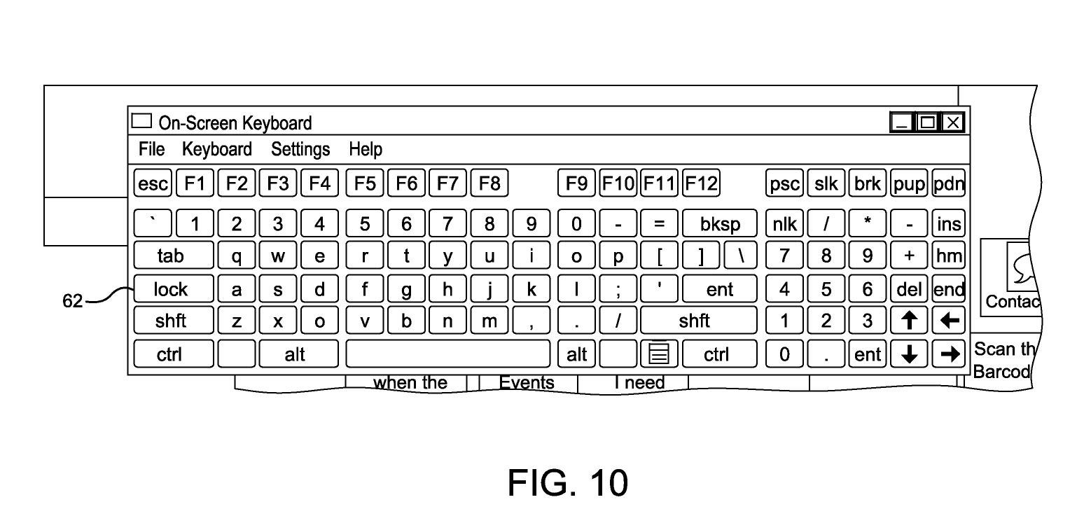

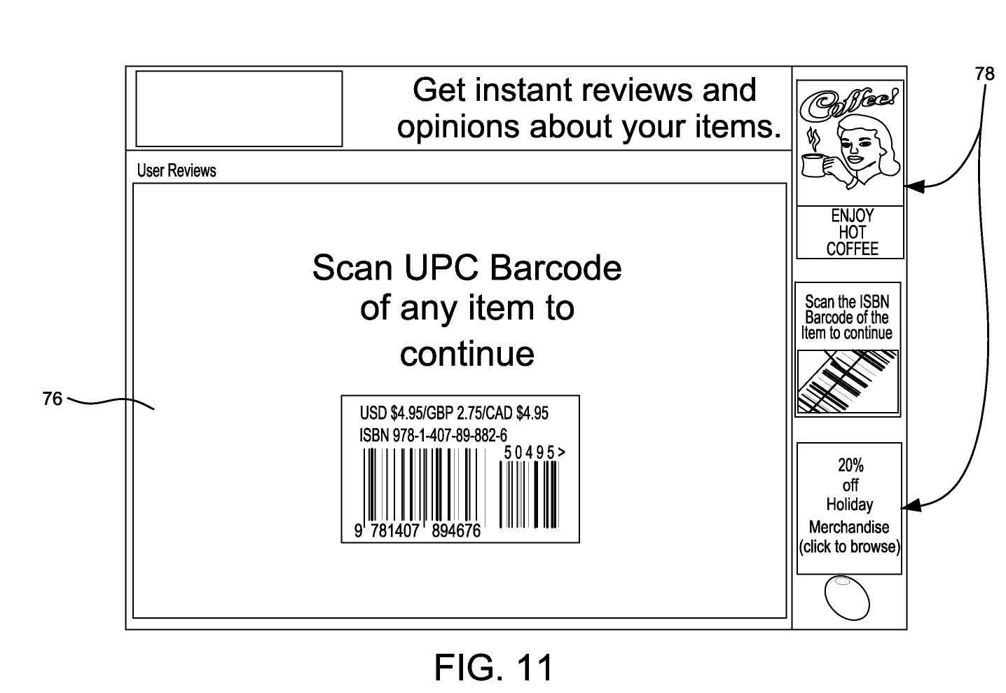

Lastly, screen 30 also preferably includes a “similar items” button 42 which, when activated, presents a list of items similar in kind to the item under scrutiny. For instance, pressing “similar items” button 42 for a book may produce a list of, say, five other books of similar subject matter appearing as a “similar items” window 44, as seen in the foreground of FIG. 5. Similarly, pressing “similar items” button 42 for a vacuum cleaner may produce a list of, say, ten other vacuum cleaners of potential interest in window 44, along with any in-store promotions that may go along with them, as discussed more fully in connection with FIGS. 10 and 11 below. It will be understood that any desired number of “similar items” may by invoked by pressing “similar items” button 42.

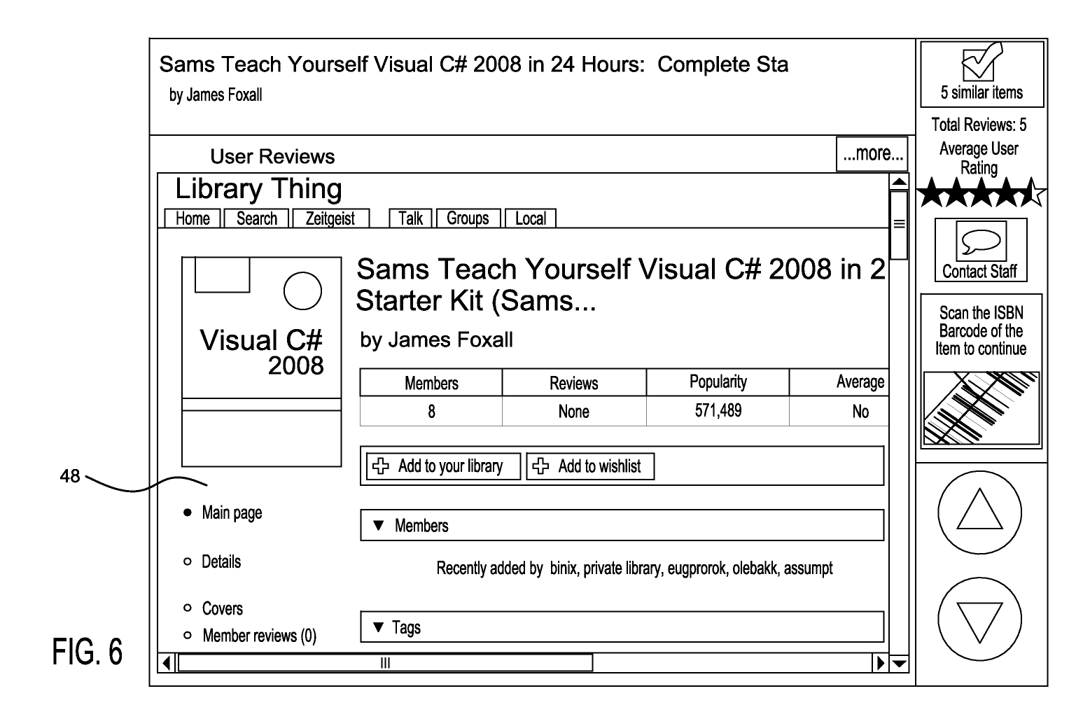

Turning to FIG. 5, once presented with the similar items in window 44, a user may select one of the similar items, identified by reference numerals 44a-44e, at which point a “reviews screen” similar to screen 30 will appear for the selected similar item. The user can then read the reviews for the selected similar item or select one or more other similar items for review. The user can repeat this cycle of selecting similar items and perusing their reviews indefinitely. In the event the user desires to learn more about a particular selected item, he or she can then press a “more” button 46 which leads the viewer to the “more information” screen 48 in FIG. 6.

As seen in FIG. 6, screen 48 provides the consumer with a wealth of information about the selected item (or selected similar item). The additional information will obviously be different for different items. That is, the additional information for books will differ from that for hammers. The additional information may be gathered from public sources or may be custom-defined for a particular installation. Again, the source is parameter driven and is defined by the library, store or other facility.

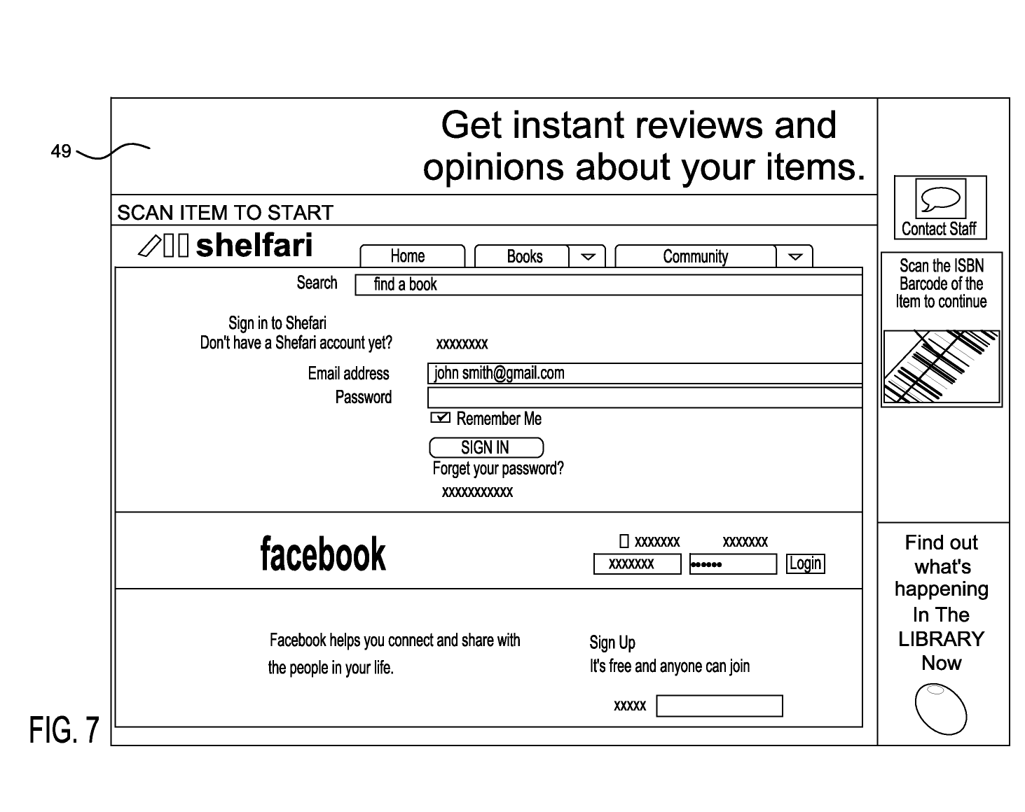

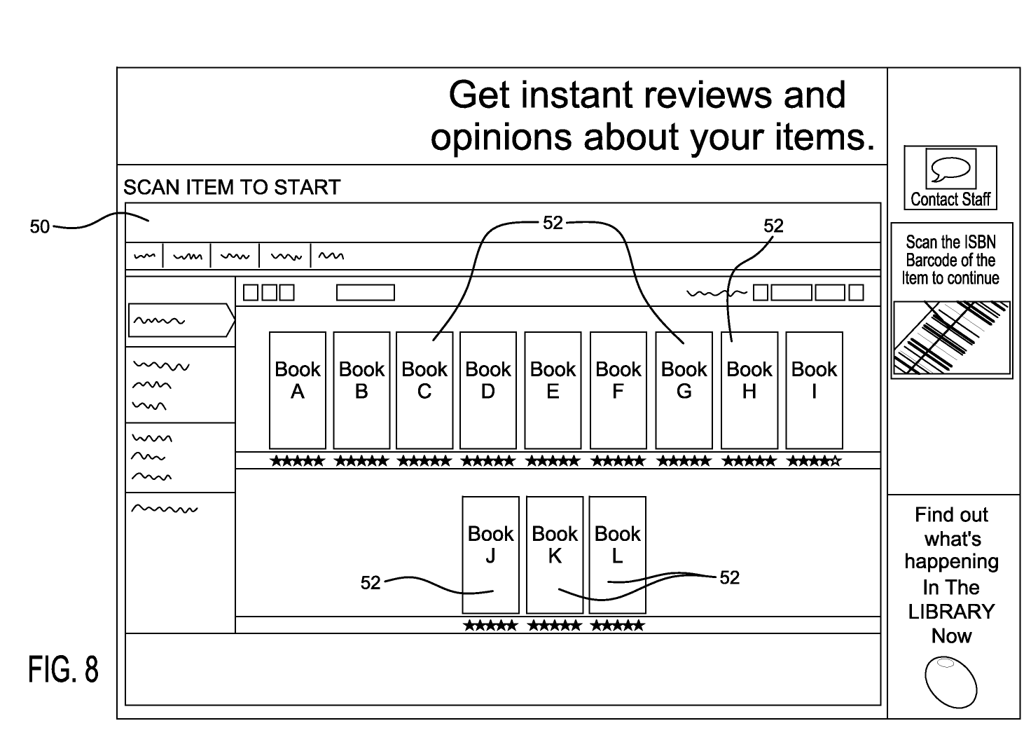

FIGS. 7 and 8 depict a feature of the invention which is especially tailored to library and bookstore patrons who have “virtual friends” that have used various on-line social networking sites to register their personal preferences and likes. Depending on the local settings, users can authenticate themselves to access some or all of these on-line resources to gain access to their own friends' lists. From screen 22 of FIG. 2, for example, a user may press an unillustrated “friends” button that invokes a screen 49 (FIG. 7) which is an illustration of two popular resources, i.e., Shelfari and Facebook, that users may wish to log into to access their personal friends' preferences information. It will be understood that any other suitable social networking sites may likewise be used for this purpose. Once logged into the appropriate “friends” site, a user may select from a list of persons who have posted their favorite, most recently read, or other books. As seen in FIG. 8, once the user has selected a “friend” from the list, that “friend's” book selection appears, whereupon the user can select one or more of the books 52 from screen 50 if he or she so chooses.

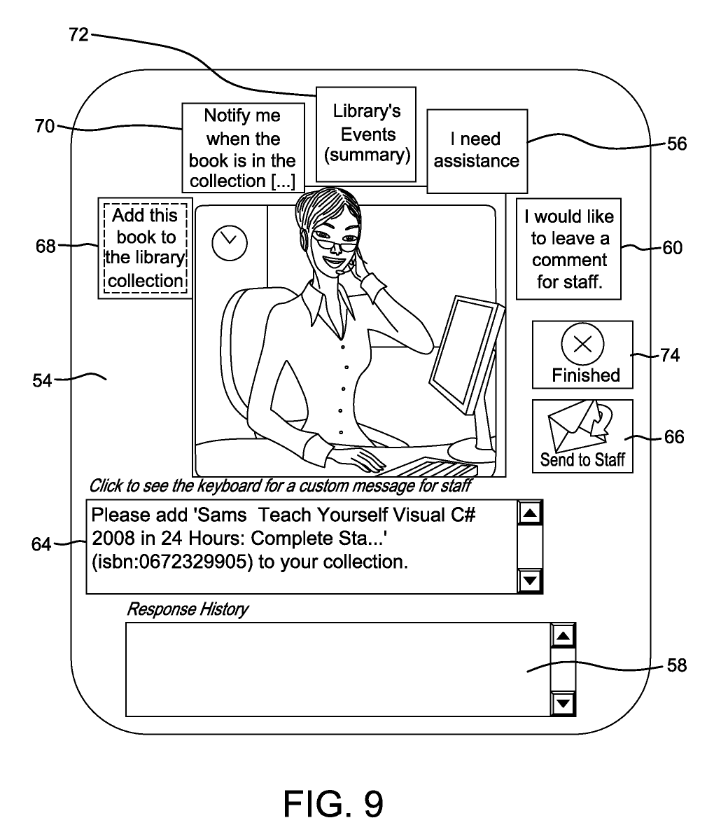

FIG. 9 reveals a screen 54 that appears when a user activates the aforementioned “contact staff” button 26. Although described in the library context, the reader will readily appreciate how its concepts may be easily adapted to a commercial environment. The “contact staff” screen may include one or more functions to enable a user to interact with trained library (or commercial) staff. More particularly, screen 54 preferably includes several buttons that permit a user to communicate with staff in different ways. For instance, screen 54 may have an “I need assistance” button 56 which places the user in contact with staff. Staff may then reply in the “response history” box 58 with a message such as “May I help you?”. A similar exchange can be initiated by pressing the “I would like to leave a comment for the staff” button 60. At this point, a pop-up, on-screen keyboard 62 (FIG. 10) appears which enables the user to type a custom message to staff in box 64 of FIG. 9. When the user is finished with the custom message, he or she presses the “send to staff” button 66 and awaits a reply from staff in box 58. This instant message exchange may last for as long as may be necessary to answer the user's particular question(s). Screen 54 may also include one or more shortcut buttons. For example, an “Add this book to the library collection” button 68 may be provided to permit a patron to expressly request that a selected book be added to the library's collection. Relatedly, a “Notify me when the book is in the collection” button 70 may be provided to let the user when the book has been added to the collection. It will also be understood that the communication between staff and patron may be by way of, or aided by, an audio and/or video feed for enabling live interaction through system 10.

Screen 54 may also include a “summary of library events” button 72 which functions and provides information similar to button 28 discussed above. When the user has completed his or her “contact staff” session he or she then presses the “finished” button 74 to exit screen 54.

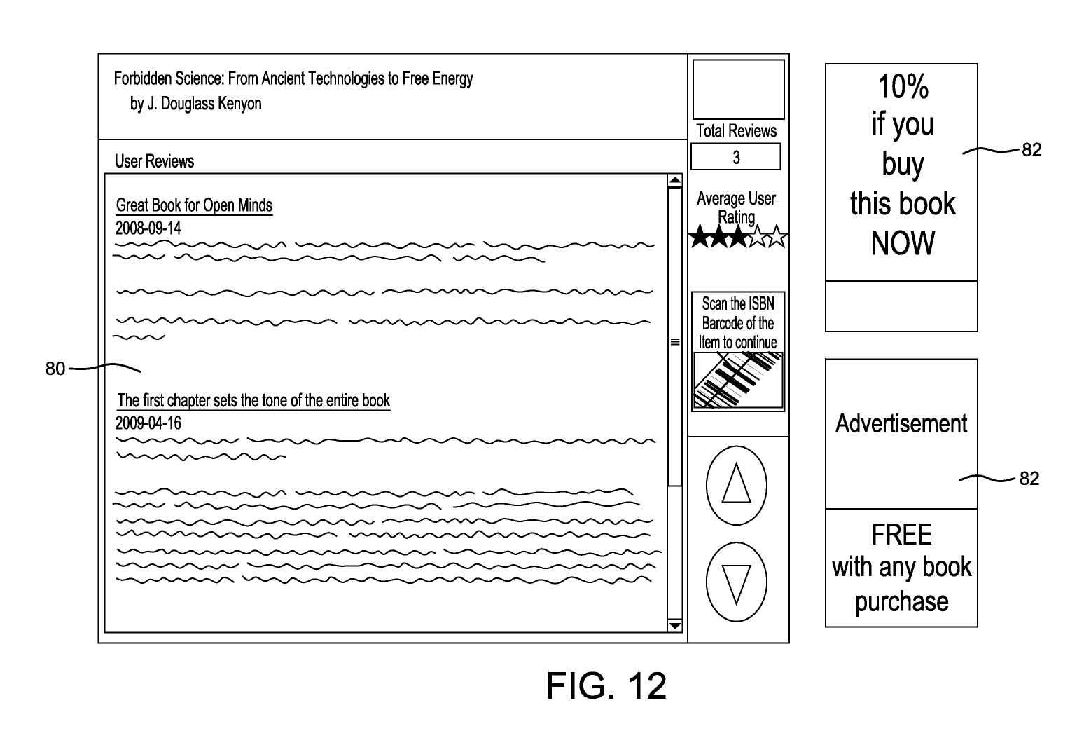

FIGS. 11 and 12 illustrate the type of screens a user might encounter in a commercial context. Referring first to FIG. 11, which is an “idle” screen similar to screen 22, there is shown a screen 76 which generates dynamically driven promotional messages 78 responsive to the item of merchandise or service item which is scanned by the scanning means. In the illustrated example, one of the messages 78 invites the user to consider purchasing coffee whereas the other offers a discount on holiday merchandise. Indeed, pressing the holiday merchandise discount button offers access to an electronic circular of discounted holiday merchandise.

In FIG. 12, which is a reviews screen 80 similar to screen 30, other dynamically driven promotional messages 82 such as discount offers and free merchandise offers are provided. It will be appreciated that the dynamically driven promotional messages are not so limited.

By way of example and not limitation, the user may be interested in undertaking a project such as building a walkway. In that event, he may scan a bag of mortar and system 10 may automatically begin to generate promotional messages similar to messages 78 and 82 for items different in kind but related in purpose for completing the project such as bricks, shovels, gloves, sand, levels, and so on. In this way, the instant system provides the merchant and the customer with potentially beneficial up-selling and cross-selling opportunities on similar items and/or items related in purpose.

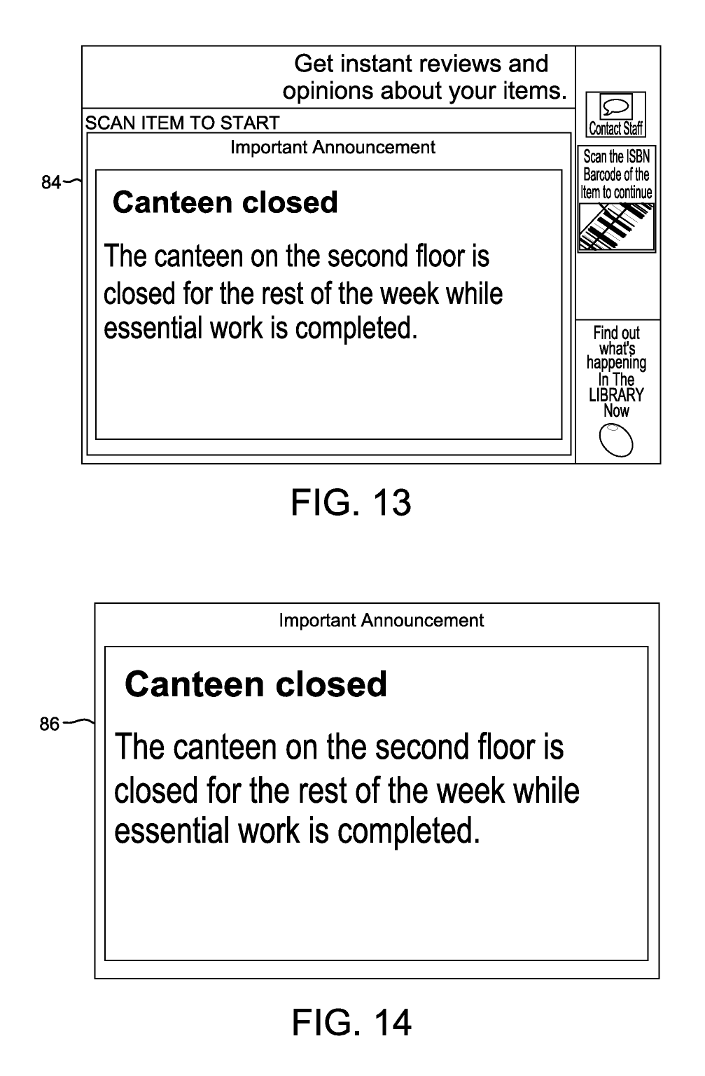

FIGS. 13 and 14 are views of another typical idle screen that might appear on the interactive graphical user interface screen prior to scanning of an item, with FIG. 14 being a full-screen version of the idle screen of FIG. 13. Unlike the idle screen 22 of FIG. 3, the screens 84 and 86 serve as digital signage for conveying any desired message the library, store or other facility may choose to convey. In FIG. 13, some of the core functions of the system according to the invention remain on the screen 84 for a user's access whereas, in FIG. 14, the entire screen 86 is devoted to the digital sign.

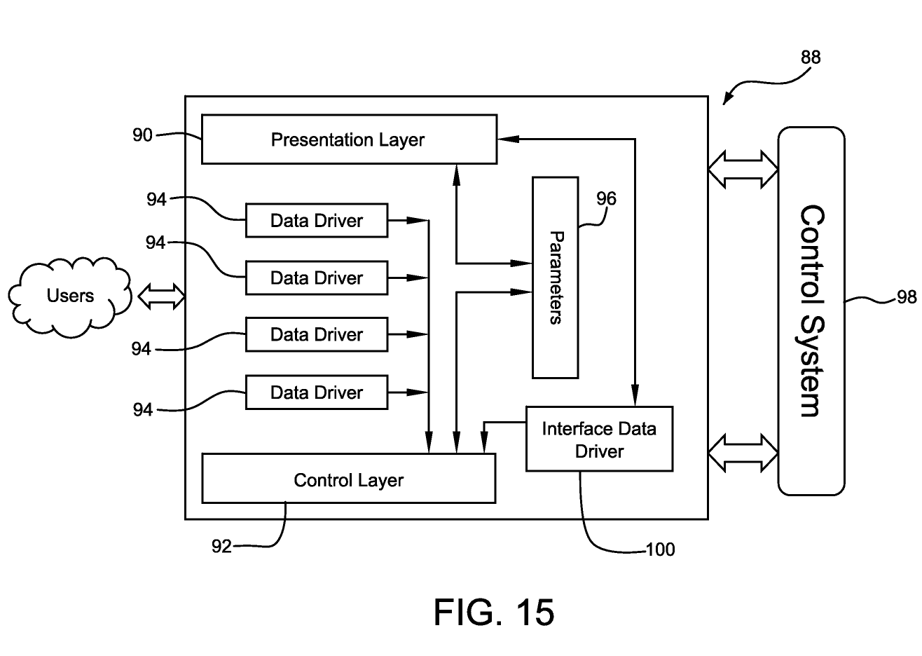

In idle modes when the device is not used, the basic screen preferably reverts to a digital sign display such as shown in FIGS. 13 and 14. The imagery displayed on screens and 86 is controlled from a centralized location via suitable control system software, as discussed in connection with FIG. 15. With digital signage capability, a store has targeted dynamic capability to promote and market in a very narrow, niche like mode with high degree of accuracy. That is to say, not only can the digital message be defaulted to something of general or specific interest, it can also be dynamically adjusted based on the items that have been scanned through the system. Hence, from a simple display, the digital signage capability may become adaptable and “smart”. For example, a device 10 according to the present invention that is placed in the electronics department of a store can start out by displaying an advertisement “idle” screen 84 or 86 for a current sale on DVD movies, but then can change the message of the “idle” screen to promote “Wii Games” because a certain number (above some threshold level) of Wii related items have been scanned through the system.

Turning to FIG. 15, there is shown the basic system architecture layout 88 of the system 10 according to the invention. Key basic components are broken up into critical modules or layers, which are internally interconnected to provide a flexible, and highly adaptable system design. Each of the key blocks, as depicted in FIG. 15, is defined below, however the basic data flow is as follows. A “request” is first made into the system. More often than not, it is generally received through the Presentation Layer 90 and passed through to the Control Layer 92, which then determines the logical sequence of actions that needs to be performed. The Control Layer 92 then invokes one of the Data Drivers 94 to connect to, inquire, receive and process the response from a multitude of external data sources. Once the response is processed, it is then passed to the Control Layer 92, which then determines via the Presentation Layer 90 the proper way to present it to the user. Asynchronous to the process, the “Interface Data Driver” 100 allows the system to receive external stimulus, which may include operational controls, modifications to the parameters as well as USER/STAFF message packets all from external source(s), which can be, but is not limited to, the control system software 98.

A more in-depth definition of each of the modules and concepts follows:

A “request” into the system is a stimulus to perform some action and provide a response. The request can take on many forms. For example, it could be a scan of an item's identifier. It could be a scan of a control card. A “control card” is a special card that has some significant meaning to the device. For example, a “shutdown” control card may mean that a device should perform an orderly log-off from any active systems and perform a system shutdown. Other control cards, such as “reset”, “lock system”, “disable some feature”, etc. are conceivable. The request could also be a button push on the display screen of graphical user interface 14, or it could also be an external stimuli from the control system software 98. No matter what is the originating source or the goal of the “request”, it is parsed, validated and passed on to the Control Layer 92 for interpretation. In addition to “standard requests”, more requests can be easily added based on the attached application and/or hardware components. For instance, the presence of an RFID reader add-on can result in a number of additional “requests” into the system, such as:
tag in the vicinity of a device (Resulting Action: possible screen change);
tag read (Resulting Action: required output);
multiple tags present (Resulting Action: screen change).

Presentation Layer 90. This module is responsible for the top user interface, which is internally composed of a number of on-screen technologies, such as HTML browsers, FLASH windows, Windows-Controls and others. The coordination and positioning of each of these sub-modules, as well as the general appearance of them is controlled within presentation layer 90. Because of its critical importance to the acceptance of the device by the users, various configurations or “skins” are possible that alter the appearance and often the functionality of the device as a whole. Furthermore, the complexity of the Presentation Layer may vary drastically based on the hardware device the present system is running on as well as the devices attached to it.

Control Layer 92. This module is responsible for all of the device's internal logic, to route the data to appropriate modules, as well as to configure the responses in such a way that they can be used by the Presentation Layer 90. The Control Layer 92 is essentially the brain of the system, knowing all that is connected to it, and all of the possible inputs it could receive. The main function of the Control Layer 92 is to interpret requests and be able to define the appropriate steps, a plan of action, that needs to be performed to satisfy the requests. Asynchronous to this operation, the Control Layer 92 is also responsible for allowing external control system software 98 to be able to communicate with the device as the request processing function is being performed.

There may also be instances, when the incoming requests are “stacked”: that is, the processing of Request #1 is not yet finished while Request #2 is coming in. It is the duty of the Control Layer 92 to properly manage this type of a situation and successfully navigate the responses to the Presentation Layer 90.

In the course of preparing a “response” to a “request”, the Control Layer 92 is in constant interaction with a number of Data Drivers 94 to gather the needed information to satisfy the request. Since Data Drivers 94 often rely on external sources for this information, they are frequently not synchronized to the needs of the Control Layer 92. That is, even though the Control Layer 92 places a request into a Data Driver 94, the Data Driver (depending on external feed), may take a while to respond, or it may not respond at all. It is then again the duty of the Control Layer 92 to determine the “value” of the importance of a particular Data Driver 94, whether it will wait for its response, or whether the rest of the response process is to proceed without it. The “value” algorithm is again performed within the Control Layer 92 and is highly application and Parameter Layer 90 driven.

Data Drivers 94. These are modules that have an inherent knowledge of the data sources for which they are responsible. As a result, these modules can be easily added to, taken away, enabled, disabled and otherwise manipulated in the system by the combination of the Control Layer 92 and the Parameters Module 96 (discussed below). The main function of these modules is to get the request from the Control Layer 92, interpret it, and then apply the required, source-specific, inquiry into the data source and wait for the response. In this course of action, a Data Driver 94 must perform some form of a “connection” to the data source. This can take the form from anything like a simple access of a local file, to a sockets connection into a remote source running a proprietary protocol, and anything in between. Since Data Drivers 94 “know” their source, these modules vary in design and complexity needed to be able to interface, navigate, query and get responses from their sources. Once the data source has provided the required response, the Data Drivers 94 then pass this information, after it has been parsed, to the Control Layer 92 for processing and eventually passage into the Presentation Layer 90.

Parameters Layer 96. This module is responsible for maintaining the continuity between the application/customer specific definitions and the operation of the overall system. This module provides systematic control over what resources are available at any one time, and to what capacity. Intricacies of each of the attached hardware devices, the current platform, the current application, as well as the current device state all factor into Parameters Layer 96 to determine how specific resources and/or modules should operate. It is also conceivable that, in addition to the fixed settings, the Parameters Layer 96 module is “smart” enough to allow temporary overrides to the operation of certain modules, such as Data Drivers 94, to allow on-demand, application-driven processing. In addition to serving the internal operations, the Parameters Layer 96 module also heavily interacts with the external control system, such as control system software 98 to allow device operation changes as the needs require.

Interface Data Driver 100. This is a special type of a data driver that is directly interconnected to the external control system software 98, as well as the internal Parameters 96 and Control 92 layers. By its unique architectural interconnections, this module provides both the data and control information flow from the device to the control system software 98. Since the system allows a two-way communication stream to occur between the device user and the device owner (e.g., customer/staff, patron/librarian, etc.), all of these interactions are carefully controlled via interface data driver 100. In addition, this module makes a clear distinction between the user interactions and device controls, and it allows external control system software 98 to pass operational parameters into the device.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. An item assessment system comprising:
means for scanning a code associated with an item; and
graphical user interface means in communication with said scanning means, said graphical user interface means being operable to display at least one of reviews information and ratings information for an item in response to scanning of the item by said scanning means.

2. The system of claim 1 wherein said graphical user interface means is a touch screen display.

3. The system of claim 1 wherein said scanning means is integral with said graphical user interface means.

4. The system of claim 1 wherein said code is a barcode.

5. The system of claim 4 wherein said barcode is a Universal Product Code (UPC).

6. The system of claim 4 wherein said barcode is an International Standard Book Number (ISBN).

7. The system of claim 1 wherein said graphical user interface means is essentially stationary.

8. The system of claim 1 wherein the system communicates wirelessly to a server.

9. The system of claim 1 wherein the system communicates via wire to a server or the Internet.

10. The system of claim 1 wherein said graphical user interface means is further operable to display information for at least one item similar in kind to a first item in response to scanning of the first item by said scanning means.

11. The system of claim 1 wherein said graphical user interface means is further operable to display information for at least one item different in kind but related in purpose to a first item in response to scanning of the first item by said scanning means.

12. The system of claim 1 wherein said graphical user interface means is further operable to display an idle screen when said scanning means has not been in use for a predetermined period of time.

13. The system of claim 12 wherein said graphical user interface means is further operable to display another idle screen different from said idle screen in response to scanning of a predetermined number of associated items by said scanning means.

14. The system of claim 1 further comprising means for allowing items to be instantly checked out and applied to a user's account in response to scanning of items by said scanning means.

15. An item assessment system comprising:
means for scanning a code associated with an item; and
graphical user interface means in communication with said scanning means, said graphical user interface means being operable to display information for at least one item similar in kind to a first item in response to scanning of the first item by said scanning means.

16. An item assessment system comprising:
means for scanning a code associated with an item; and
graphical user interface means in communication with said scanning means, said graphical user interface means being operable to display information for at least one item different in kind but related in purpose to a first item in response to scanning of the first item by said scanning means.

17. An item assessment system comprising:
means for scanning a code associated with an item; and
graphical user interface means in communication with said scanning means, said graphical user interface means being operable to display (1) an idle screen when said scanning means has not been in use for a predetermined period of time, and (2) another idle screen different from said idle screen in response to scanning of a predetermined number of associated items by said scanning means.

18. An item assessment system comprising:
means for scanning a code associated with an item; and
graphical user interface means in communication with said scanning means, said graphical user interface means being operable to display directions to an item located in a facility in response to scanning of the item by said scanning means.

19. An item assessment system comprising:
means for scanning a code associated with an item; and
graphical user interface means in communication with said scanning means, said graphical user interface means being operable to display sales promotions in response to scanning of items by said scanning means.

20. An item assessment system comprising:
means for scanning a code associated with an item; and
graphical user interface means in communication with said scanning means, said graphical user interface means being operable to display items of interest to friends of a user in response to scanning of items by said scanning means.

21. A method for assessing items comprising the steps of:
(a) scanning a code associated with an item using a scanning means; and
(b) in response to scanning of said code by said scanning means, displaying at least one of reviews information and ratings information for the item on a graphical user interface means in communication with said scanning means.

22. The method of claim 21 wherein said graphical user interface means is essentially stationary.

23. A method for assessing items comprising the steps of:
(a) scanning a code associated with a first item using a scanning means; and
(b) in response to scanning of said code by said scanning means, displaying information for at least one item similar in kind to a first item on a graphical user interface means in communication with said scanning means.

24. The method of claim 23 wherein said graphical user interface means is essentially stationary.

25. A method for assessing items comprising the steps of:
(a) scanning a code associated with a first item using a scanning means; and
(b) in response to scanning of said code by said scanning means, displaying information for at least one item different in kind but related in purpose to a first item on a graphical user interface means in communication with said scanning means.

26. The method of claim 25 wherein said graphical user interface means is essentially stationary.

27. A method for assessing items comprising the steps of:
(a) scanning a code associated with a first item using a scanning means; and
(b) in response to scanning of said code by said scanning means, displaying on a graphical user interface means in communication with said scanning means (1) an idle screen when said scanning means has not been in use for a predetermined period of time, and (2) another idle screen different from said idle screen in response to scanning of a predetermined number of associated items by said scanning means.

28. The method of claim 27 wherein said graphical user interface means is essentially stationary.

29. A method for assessing items comprising the steps of:
(a) scanning a code associated with an item using a scanning means; and
(b) in response to scanning of said code by said scanning means, displaying directions to an item located in a facility on a graphical user interface means in communication with said scanning means.

30. The method of claim 29 wherein said graphical user interface means is essentially stationary.

31. A method for assessing items comprising the steps of:
(a) scanning a code associated with an item using a scanning means; and
(b) in response to scanning of said code by said scanning means, displaying sales promotions on a graphical user interface means in communication with said scanning means.

32. The method of claim 31 wherein said graphical user interface means is essentially stationary.

33. A method for assessing items comprising the steps of:
(a) scanning a code associated with an item using a scanning means; and
(b) in response to scanning of said code by said scanning means, displaying items of interest to friends of a user on a graphical user interface means in communication with said scanning means.

34. The method of claim 33 wherein said graphical user interface means is essentially stationary.

35. A method for enhancing consumer interaction within a facility comprising the steps of:
(a) scanning a code associated with an item using a scanning means; and
(b) in response to scanning of said code by said scanning means, displaying information of interest to a user on a graphical user interface means in communication with said scanning means.

36. The method of claim 35 wherein said graphical user interface means is essentially stationary.

37. The method of claim 36 wherein said scanning means is integral with said graphical user interface means.

38. The method of claim 35 wherein said information of interest to a user includes at least one of reviews information and ratings information for an item.

39. The method of claim 35 wherein said information of interest to a user includes information for at least one item similar in kind to a first item.

40. The method of claim 35 wherein said information of interest to a user includes information for at least one item different in kind but related in purpose to a first item.

41. The method of claim 35 wherein said information of interest to a user includes an idle screen when said scanning means has not been in use for a predetermined period of time.

42. The method of claim 41 wherein said information of interest to a user includes another idle screen different from said idle screen in response to scanning of a predetermined number of associated items by said scanning means.

43. The method of claim 35 wherein said information of interest to a user includes instant check out information.

44. The method of claim 35 wherein said information of interest to a user includes directions to an item located in the facility.

45. The method of claim 35 wherein said information of interest to a user includes sales promotions.

46. The method of claim 35 wherein said information of interest to a user includes items of interest to friends of a user.
